(19) United States
(12) Patent Application Publication
(10) Pub. No.: US 2011/0118921 A1
(43) Pub. Date: May 19, 2011

(54) SYSTEM AND METHOD FOR CONTROLLING ECONOMICAL DRIVING OF HYBRID VEHICLE AND A HYBRID VEHICLE EMBODYING SAME

(75) Inventors: Joon Young Park, Seoul (KR); Sang Joon Kim, Seoul (KR)

(73) Assignee: HYUNDAI MOTOR COMPANY, Seoul (KR)

(21) Appl. No.: 12/847,602

(22) Filed: Jul. 30, 2010

(30) Foreign Application Priority Data
Nov. 19, 2009 (KR) 10-2009-0112248

(51) Int. Cl. G06F 19/00; G06F 17/00

(52) U.S. Cl. 701/22; 180/65.265

(57) ABSTRACT

Featured are apparatuses and methods for economical driving of a hybrid vehicle. Such methods include determining a present fuel consumption efficiency control value by considering present fuel consumption as a real consumption amount of a fuel and a battery, determining a driving pattern fuel consumption efficiency control value by considering fuel consumption determined by a vehicle speed and a driving condition, and guiding economical driving to a driver by applying a weight value factor to the present fuel consumption efficiency control value and a driving pattern fuel consumption efficiency control value. Also featured is a hybrid vehicle embodying such apparatuses and methods.

### CROSS-REFERENCE TO RELATED APPLICATION

This application claims priority to and the benefit of Korean Patent Application No. 10-2009-0112248 filed in the Korean Intellectual Property Office on Nov. 19, 2009, the entire contents of which are incorporated herein by reference.

### BACKGROUND OF THE INVENTION

(a) Field of the Invention

The present invention generally relates to hybrid vehicles. More particularly, the present invention relates to a control apparatus for economical driving of hybrid vehicles offering optimized economical driving, and methods thereof and also to a hybrid vehicle embodying such a control apparatus.

(b) Description of the Related Art

A hybrid vehicle typically includes a reciprocating engine and an electric motor (motor/generator) that is operated by a high voltage battery to assist the engine while the vehicle is being operated. Such an arrangement offers high energy efficiency and low emission through the combination of the two power sources.

When considering power performance, fuel consumption, and drivability for the hybrid vehicle, an automatic transmission is generally provided such that an optimized gear shifting ratio is automatically determined shift gears.

In some gasoline vehicles as are known in the art, the present fuel consumption amount caused by quick or sudden acceleration by a driver is displayed in a predetermined method through a display means embodied in the cluster of the vehicle that is generally visible to the vehicle driver. In addition, a driving pattern such as the stroke of an accelerator pedal and/or the brake pedal is displayed through such a display means of the cluster. This is generally done to induce or motivate the driver so they perform economical driving.

However, the hybrid vehicle controls an engine and a motor differently according to a driving condition thereof as compared to a conventional engine only powered vehicle. Thus, while the accelerator pedal or the brake pedal are equally controlled, the fuel consumption amount, the battery consumption amount, and the regenerative braking amount are different. As a result, a uniform or economical driving pattern cannot be induced.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention features a control apparatus for a hybrid vehicle having advantages affects inducing economical driving when using such a hybrid vehicle. Also feature is a hybrid vehicle embodying such a control apparatus. In further aspects/embodiments there are featured methods for guiding optimized economical driving. Such methods include applying a weight value factor to a fuel consumption control value of a driving pattern determined by a present fuel consumption efficiency control value that is calculated by a fuel consumption amount equivalent, vehicle speed, and driver operations.

In further aspects/embodiments, there is featured a control apparatus being configured to induce or motivate economical driving of a hybrid vehicle. Such a vehicle includes an engine and a motor. In further embodiments, such a vehicle includes an engine controller controlling output torque of an engine, a motor controller controlling output torque of a motor, and a display portion. The display portion is provided for displaying driving information according to a driving condition. Such a vehicle also includes a hybrid controller guiding an economic driving condition by considering a present fuel consumption efficiency control value according to the operation of the engine and the motor and a driving pattern fuel consumption efficiency control value according to vehicle speed and a driving condition.

In yet further aspects/embodiments of the present invention there is featured an economical control method for a hybrid vehicle. Such methods include determining a present fuel consumption efficiency control value by considering present fuel consumption as a real consumption amount of a fuel and a battery, determining a driving pattern fuel consumption efficiency control value by considering fuel consumption determined by a vehicle speed and a driving condition, and guiding economical driving to a driver by applying a weight value factor to the present fuel consumption efficiency control value and a driving pattern fuel consumption efficiency control value.

In the present invention as stated above, present fuel consumption and a general driving pattern are applied to optimize a fuel and battery consumption amount and guide economical driving such that productivity of the hybrid vehicle is improved.

Also featured is a hybrid vehicle embodying such control apparatuses and methods of the present invention.

Other aspects and embodiments of the present invention are described herein.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships and the like, and includes hybrid vehicles, electric vehicles, plug-in hybrid vehicles, hydrogen powered vehicles and other alternative fuel vehicles (e.g., fuels derived from resources other than petroleum). As referred to herein, a hybrid vehicle is a vehicle that has two or more sources of power, for example both petroleum (e.g., gasoline, diesel) powered and electric powered vehicles.

### BRIEF DESCRIPTION OF THE DRAWINGS

For a fuller understanding of the nature and desired objects of the present invention, reference is made to the following detailed description taken in conjunction with the accompanying drawing figures wherein like reference characters denote corresponding parts throughout the several views and wherein:

FIG. 1 a schematic view that shows a regenerative braking torque control apparatus and a hybrid vehicle according to the present invention.

FIG. 2 is a high level flow diagram of a process or methodology for regenerative braking torque control for a hybrid vehicle according to the present invention.

For a fuller understanding of the nature and desired objects of the present invention, reference is made to the following detailed description taken in conjunction with the accompanying drawing figures wherein like reference characters denote corresponding parts throughout the several views and wherein:
10: ECU
20: HCU
30: MCU
40: battery
50: BMS
60: ABS
70: motor
80: engine
90: engine clutch
100: transmission
110: vehicle speed detector

### DETAILED DESCRIPTION OF THE EMBODIMENTS

In the following detailed description, certain aspects and/or embodiments of the present invention are shown and described, by way of illustration. As those skilled in the art would realize, the described embodiments can be modified in various different ways, all without departing from the spirit or scope of the present invention. The drawings and description are to be regarded as illustrative in nature and not restrictive, and like reference numerals designate like elements throughout the specification.

According to aspects/embodiments, there is featured a control apparatus for economical driving of a hybrid vehicle having an engine and a motor. Such a control apparatus includes a display portion and a hybrid controller. The display portion includes any of a number of displays as are known to those skilled in the art and more particularly those utilized and integrated into the cluster of a dashboard of a vehicle, including a hybrid vehicle. Such a display displays driving information such information being representative a driving condition.

The hybrid controller is configured and arranged so as to guide an economical driving condition by considering a present fuel consumption efficiency control value according to the operation of the engine and the motor and a driving pattern fuel consumption efficiency control value according to vehicle speed and a driving condition.

In further embodiments, the display displays information relating to the economical driving of the hybrid vehicle.

In yet further embodiments, the hybrid controller applies a fuel consumption amount equivalent and a regeneration rate to calculate a present fuel consumption efficiency control value including a fuel consumption amount and a battery consumption amount.

In yet further embodiments, the hybrid controller is configured and arranged so as to determine a fuel consumption rate equivalent using the following relationship:

$$if ( Bat\_Cur \times Bat\_Volt > 0 ) \\ = \frac{Bat\_Cur \times Bat\_Volt}{Bat\_Ave \_Chg \_Eff \times Eng\_Ave \_Eff \times Eqv\_Fuel}$$

$$else \\ = \frac{Bat\_Cur \times Bat\_Volt \times Bat\_Ave \_Dch \_Eff}{Eng\_Ave \_Eff \times Eqv\_Fuel}$$

Where Bat_Cur is battery current (A), Bat_Volt is battery voltage (V), Bat_Ave_Chg_Eff is battery average charging efficiency, Bat_Ave_Dch_Eff is battery average discharging efficiency, Eng_Ave_Eff is engine average efficiency, and Eqv_Fuel is fuel thermal equivalent (μl/W).

In yet further aspects/embodiments of the present invention, there also is featured a hybrid vehicle including an engine, an electric motor, and any of the control apparatuses for economical driving of a hybrid vehicle described herein. In more particular embodiments, the electric motor is a motor/generator that operably coupled to an output of the engine so as to at least assist the engine during operation of the vehicle and in further embodiments is capable of regenerative braking.

In more particular aspects/embodiments, the control apparatus includes a display portion and a hybrid controller. The display portion displays driving information such information be representative a driving condition. The hybrid controller is configured and arranged so as to guide an economical driving condition by considering a present fuel consumption efficiency control value according to the operation of the engine and the motor and a driving pattern fuel consumption efficiency control value according to vehicle speed and a driving condition. Also, the driving information being displayed includes information for guiding economical driving provided by said hybrid controller.

In yet further embodiments, the hybrid controller adds a determined present fuel consumption efficiency control value to a determined driving pattern fuel consumption efficiency control value, the product of which is used to guide economical driving.

In yet further embodiments, the hybrid vehicle further includes a power supply for storing electricity and the regenerative braking is used to generate electricity which is stored in the power supply.

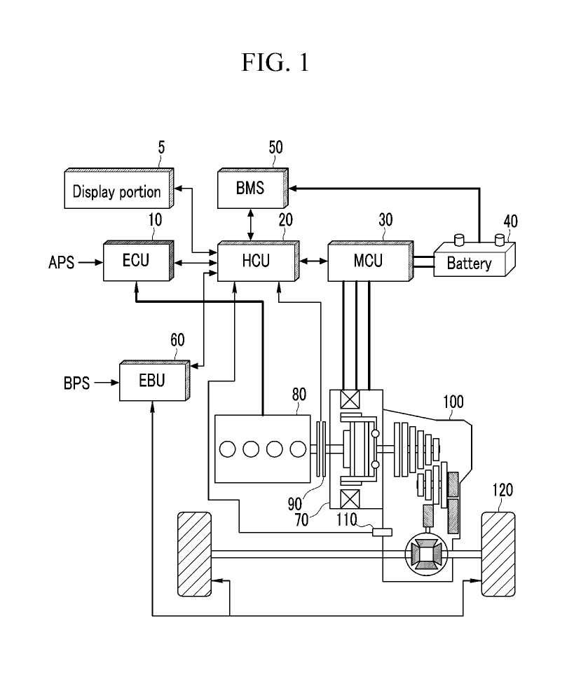

Referring now to FIG. 1 there is shown a schematic view that shows a regenerative braking torque control apparatus 210 and a hybrid vehicle 200 according to the present invention.

Such a hybrid vehicle 200 and regenerative braking torque control apparatus 210 includes a display portion 5, an engine control unit (ECU) 10, a hybrid control unit (HCU) 20, a motor control unit (MCU) 30, a battery 40, a battery management system (BMS) 50, an electric brake unit (EBU) 60, a motor 70, an engine 80, an engine clutch 90, a transmission 100, a vehicle speed sensor 110, and a wheel 120.

The display portion 5 preferably is embodied in the cluster or dashboard cluster of a vehicle and is configured so as to display general information according to driving of a hybrid vehicle, and fuel consumption information including present fuel consumption and driving pattern fuel consumption to induce optimized economical driving. As also indicated herein, the display portion includes any of a number of displays as are known to those skilled in the art and more particularly those utilized and integrated into the cluster of a dashboard of a vehicle, including a hybrid vehicle.

As is known to those skilled in the art, the motor 70 is a motor generator that in one operating mode operates as a motor to provide power and torque to assist the engine and in another operating mode it functions as a generator so as to cause regenerative braking of the vehicle. The energy developed from regenerative braking is dissipated using any of a number of techniques known to those skilled in the art and/or the energy is used to charge the motor power source. In an illustrative embodiment, the power source is a battery/batteries. Reference herein to a motor shall be understood to mean a motor when power or torque is being outputted abd to a generator when electrical power is being generated by the motor.

As also indicated herein, the engine 80 is any of a number of engines known to those skilled in the art, or hereinafter developed that utilize any of a number of combustible materials to generate power or torque.

The ECU 10 together with the HCU 20 connected to a network controls output torque of the engine 80 according to a signal of an accelerator position sensor (APS) (not shown).

The HCU 20 controls each controller through a network according to a driving demand and condition to control output torque of the engine 80 and the motor 70. If a braking demand is detected from the EBU 60, the HCU calculates a regenerative braking amount of the motor 70 and controls the hydraulic pressure supplied to the brake cylinder and thus the brakes for each wheel 120 through the EBU 60 so as to perform regenerative braking and deceleration control.

The HCU 20 applies a fuel consumption amount and a regenerative rate according to operations of the engine 80 and the motor 70 of the hybrid vehicle to calculate a present fuel consumption efficiency including a fuel consumption amount and a battery consumption amount, and multiplies a predetermined first weight value factor thereto to determine a present fuel consumption efficiency control value.

Also, the HCU applies a predetermined second weight value factor to a driving pattern value determined by vehicle speed and driving demand of a driver to calculate a driving pattern fuel consumption efficiency control value.

Further, the HCU adds the present fuel consumption efficiency control value to a driving pattern fuel consumption efficiency control value, the product of which is preferably used to guide economical driving.

The HCU 20 calculates a fuel consumption amount equivalent (e.g., as a gasoline consumption amount), which is applied in calculating present fuel consumption efficiency, based on a real gasoline fuel consumption amount and battery consumption amount.

The present fuel consumption efficiency control value can be different in a condition of the same driver in the same system, and the driving pattern fuel consumption efficiency control value is predetermined value based on a driving condition.

With regard to the fuel consumption amount equivalent, a travel distance per unit fuel equivalent (Km/l) including a vehicle speed is applied thereto in an acceleration (operating) condition, a fuel regeneration rate per unit deceleration is applied thereto in a regenerative braking condition, and an idling time per unit fuel equivalent is applied thereto in an idling stop condition.

When deceleration is small and the regeneration rate equivalent is large in the regenerative braking condition, the fuel regeneration rate per unit deceleration is large.

Also, vehicle speed, an APS signal, a BPS signal, and an air-con/heater switch signal are applied to the driving pattern fuel consumption efficiency control value.

The HCU 20 transforms charged and discharged electric power provided by the MCU 30 to a fuel consumption rate, and adds a fuel consumption rate of the engine 80 provided by the ECU 10 thereto so as to calculate a total fuel consumption rate equivalent.

The fuel consumption rate equivalent is determined using the following relationship:

$$if ( Bat\_Cur \times Bat\_Volt > 0 ) \\ = \frac{Bat\_Cur \times Bat\_Volt}{Bat\_Ave \_Chg \_Eff \times Eng\_Ave \_Eff \times Eqv\_Fuel} \\ else \\ = \frac{Bat\_Cur \times Bat\_Volt \times Bat\_Ave \_Dch \_Eff}{Eng\_Ave \_Eff \times Eqv\_Fuel} \qquad ( Equation 1 )$$

In Equation 1, Bat_Cur is battery current (A), Bat_Volt is battery voltage (V), Bat_Ave_Chg_Eff is battery average charge efficiency, Bat_Ave_Dch_Eff is battery average discharge efficiency, Eng_Ave_Eff is engine average efficiency, and Eqv_Fuel is fuel thermal equivalent (μl/W).

The MCU 30 uses a battery consumption amount to control operation and torque of the motor 70, and stores electricity generated by the motor 70 in the battery 40 or power source/supply during the regenerative braking.

The battery 40 or power supply/source supplies the motor 70 with electric power in a hybrid mode (HEV) and a motor mode (EV), and is charged with electricity retrieved by the motor 70 during the regenerative braking control.

The BMS 50 detects voltage, current, and temperature of the battery 40, controls a state of charge (SOC) state and charging and discharging current amount, and offers the pertinent data to the HCU 20 through a network.

The EBU 60 calculates braking torque demanded from the BPS signal made by a driver, and supplies hydraulic pressure to a hydraulic cylinder and thus the brakes of the wheel 120 according to the braking torque.

The motor 70 that is operated by a battery or power source/supply according to an operating signal of the MCU 30 in the hybrid mode (HEV) assists the output torque of the engine 80, and the motor that is operated by the MCU 30 moves the vehicle without the output torque of the engine in the motor mode (EV).

The output torque of the engine 80 is controlled by the ECU 20.

The engine clutch 90 is disposed between the engine 80 and the motor 70 and is operated by the HCU 20.

The automatic transmission 100 changes a gear to a target step determined by a transmission control unit (TCU) (not shown) based on vehicle speed, throttle opening rate, and input torque so as to accelerate the vehicle.

The vehicle speed sensor 110 detects the driving speed of the vehicle from rotation speed of an output shaft of the transmission.

An economical driving of the hybrid vehicle including the functions as stated above is controlled as follows.

The hybrid vehicle is controlled according to respective modes such as general operation of which a detailed description will be omitted, and the economical driving control offered by the engine and the motor will be described.

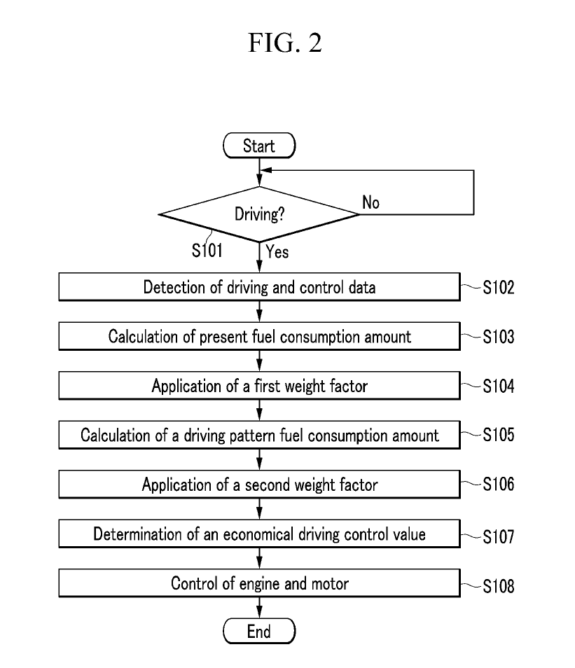

Referring now to FIG. 2, there is shown is a high level flow diagram of a process or methodology for regenerative braking torque control for a hybrid vehicle according to the present invention.

In the process of driving the hybrid vehicle (Step S101). the HCU 20 detects and analyzes driving and control data from the control devices connected through a network (Step S102).

That is to say, the HCU gathers and analyses an Accelerator Pedal Switch (APS) signal as a stroke of an accelerator pedal, a Brake Pedal Switch

(BPS) signal as a stroke of a brake pedal, acceleration rate, a creep condition, an inertial driving condition, a braking condition, vehicle speed, an air-con system or heater condition, and an SOC, current, and voltage of a battery.

Then, based on the gathered driving and control data according to the operation of the engine 80 and the motor 70, the fuel consumption amount equivalent and the regeneration rate are applied to calculate the present fuel consumption efficiency including fuel consumption amount and battery consumption amount (Step S103), and a predetermined first weight value factor is applied to the present fuel consumption efficiency (Step S104).

The fuel consumption amount equivalent applied to calculate the present fuel consumption efficiency is calculated from the fuel consumption (e.g., gasoline fuel) amount of the engine 80 and the consumption amount of the battery, wherein the battery consumption amount is exchanged into a fuel consumption amount.

A travel distance per unit fuel equivalent (Km/l) including vehicle speed is applied to the fuel consumption amount equivalent in an acceleration condition, a fuel regeneration rate per unit deceleration is applied thereto in a regenerative braking condition, and an idling time per unit fuel equivalent is applied thereto in an idling stop condition.

If deceleration of the vehicle is smaller and the regeneration rate equivalent is larger, the fuel regeneration rate per unit deceleration is improved in the regenerative braking condition.

The fuel consumption rate equivalent is calculated by adding the fuel consumption rate of the engine 80 to the charged and discharged electricity of the battery, wherein the charged and discharged electricity is changed into a fuel consumption rate, and is formulated as provided in Equation 1, which is reproduced below for convenience.

$$if ( Bat\_Cur \times Bat\_Volt > 0 ) \\ = \frac{Bat\_Cur \times Bat\_Volt}{Bat\_Ave \_Chg \_Eff \times Eng\_Ave \_Eff \times Eqv\_Fuel} \\ else \\ = \frac{Bat\_Cur \times Bat\_Volt \times Bat\_Ave \_Dch \_Eff}{Eng\_Ave \_Eff \times Eqv\_Fuel} \qquad ( Equation 1 )$$

As indicated herein, in this equation, Bat_Cur is battery current (A), Bat_Volt is battery voltage (V), Bat_Ave_Chg_Eff is battery average charging efficiency, Bat_Ave_Dch_Eff is battery average discharging efficiency, Eng_Ave_Eff is engine average efficiency, and Eqv_Fuel is a fuel thermal equivalent (μl/W).

If the present fuel consumption efficiency is calculated by a fuel consumption amount and a battery consumption amount according to a system in a condition of the same driver, a control value for controlling the engine 80 and the motor 70 is determined.

Then, vehicle speed, APS data as a driving signal of a driver, BPS data as a braking signal, and an air-con/heater operation signal are detected to determine a driving pattern (Step S105), and a predetermined second weight value factor is applied thereto to calculate a fuel pattern fuel consumption control value irrespective of the usage of the fuel and the battery (Step S106).

Further, in Step S104, a present fuel consumption efficiency control value calculated by a present fuel consumption efficiency and a driving pattern fuel consumption efficiency control value calculated by a driving pattern fuel consumption are summed to determine a control value of economical driving offering optimized fuel consumption in control of the engine 80 and the motor 70 (Step S107).

If the control value of economical driving is determined as provided above, the output of the engine 80 is controlled by the ECU 10 connected to a network and the output of the motor 70 is controlled by the MCU 30 so as to guide a minimized fuel consumption amount and battery consumption amount, and the driving pattern thereof or driving information relating to economical driving is displayed through the display portion 5 such that a driver performs economical driving (Step S108).

While the present invention has been described in detail with reference to the preferred embodiments, those skilled in the art will appreciate that various modifications and substitutions can be made thereto without departing from the spirit and scope of the present invention as set forth in the appended claims.

What is claimed is:

1. A control apparatus for economical driving of a hybrid vehicle having an engine and a motor, said control apparatus comprising:
an engine controller controlling output torque of an engine;
a motor controller controlling output torque of a motor;
a display portion displaying driving information according to a driving condition; and
a hybrid controller guiding an economical driving condition by considering a present fuel consumption efficiency control value according to the operation of the engine and the motor and a driving pattern fuel consumption efficiency control value according to vehicle speed and a driving condition.

2. The control apparatus for economical driving of a hybrid vehicle of claim 1, wherein the hybrid controller applies a fuel consumption amount equivalent and a regeneration rate to calculate a present fuel consumption efficiency control value including a fuel consumption amount and a battery consumption amount.

3. The control apparatus for economical driving of a hybrid vehicle of claim 1, wherein the hybrid controller applies a predetermined weight value factor to the present fuel consumption efficiency control value and the driving pattern fuel consumption efficiency control value.

4. The control apparatus for economical driving of a hybrid vehicle of claim 2, wherein the hybrid controller applies a travel distance per unit fuel equivalent (Km/l) including a vehicle speed in an acceleration condition, a fuel regeneration rate per unit deceleration in a regenerative braking condition, and an idling time per unit fuel equivalent in an idling time to calculate a fuel consumption amount equivalent.

5. The control apparatus for economical driving of a hybrid vehicle of claim 4, wherein the hybrid controller applies a vehicle speed and an accelerator pedal stroke, a brake pedal stroke, and an air-con/heater operation condition to determine a driving pattern fuel consumption efficiency control value.

6. The control apparatus for economical driving of a hybrid vehicle of claim 2, wherein the hybrid controller applies the following equation to determine a fuel consumption rate equivalent:
$$if ( Bat\_Cur \times Bat\_Volt > 0 ) \\ = \frac{Bat\_Cur \times Bat\_Volt}{Bat\_Ave \_Chg \_Eff \times Eng\_Ave \_Eff \times Eqv\_Fuel}$$
$$else \\ = \frac{Bat\_Cur \times Bat\_Volt \times Bat\_Ave \_Dch \_Eff}{Eng\_Ave \_Eff \times Eqv\_Fuel}$$
wherein Bat_Cur is battery current (A), Bat_Volt is battery voltage (V), Bat_Ave_Chg_Eff is battery average charging efficiency, Bat_Ave_Dch_Eff is battery average discharging efficiency, Eng_Ave_Eff is engine average efficiency, and Eqv_Fuel is fuel thermal equivalent (μl/W).

7. An economical control method of a hybrid vehicle, comprising the step(s) of:
determining a present fuel consumption efficiency control value by considering present fuel consumption as a real consumption amount of a fuel and a battery;
determining a driving pattern fuel consumption efficiency control value by considering fuel consumption determined by vehicle speed and a driving condition; and
guiding economical driving to a driver by applying a weight value factor to the present fuel consumption efficiency control value and a driving pattern fuel consumption efficiency control value.

8. The economical control method of a hybrid vehicle of claim 7, wherein the present fuel consumption is calculated by applying a fuel consumption amount equivalent.

9. The economical control method of claim 8, wherein the fuel consumption amount equivalent is calculated by transforming a gasoline fuel consumption amount of the engine and a battery usage amount to a gasoline consumption amount, a travel distance per unit fuel equivalent (Km/l) including vehicle speed in an acceleration condition is applied, a fuel regeneration rate per unit deceleration in a regenerative braking condition is applied, and an idling time per unit fuel equivalent in an idling time is applied.

10. The economical control method of claim 8, wherein the present fuel consumption efficiency control value is a fuel consumption amount according to a driving and a fuel consumption amount according to a battery consumption amount, and the driving pattern fuel consumption efficiency control value is a predetermined value according to a driving condition.

11. A control apparatus for economical driving of a hybrid vehicle having an engine and a motor, said control apparatus comprising:
a display portion that displays driving information such information being representative a driving condition; and
a hybrid controller being configured and arranged so as to guide an economical driving condition by considering a present fuel consumption efficiency control value according to the operation of the engine and the motor and a driving pattern fuel consumption efficiency control value according to vehicle speed and a driving condition.

12. The control apparatus of claim 11, wherein the display includes displaying information relating to the economical driving of the hybrid vehicle.

13. The control apparatus of claim 11, wherein the hybrid controller applies a fuel consumption amount equivalent and a regeneration rate to calculate a present fuel consumption efficiency control value including a fuel consumption amount and a battery consumption amount.

14. The control apparatus of claim 2, wherein the hybrid controller is configured and arranged so as to determine a fuel consumption rate equivalent using the following relationship:
$$if ( Bat\_Cur \times Bat\_Volt > 0 ) \\ = \frac{Bat\_Cur \times Bat\_Volt}{Bat\_Ave \_Chg \_Eff \times Eng\_Ave \_Eff \times Eqv\_Fuel}$$
$$else \\ = \frac{Bat\_Cur \times Bat\_Volt \times Bat\_Ave \_Dch \_Eff}{Eng\_Ave \_Eff \times Eqv\_Fuel}$$
wherein Bat_Cur is battery current (A), Bat_Volt is battery voltage (V), Bat_Ave_Chg_Eff is battery average charging efficiency, Bat_Ave_Dch_Eff is battery average discharging efficiency, Eng_Ave_Eff is engine average efficiency, and Eqv_Fuel is fuel thermal equivalent (μl/W).

15. A hybrid vehicle comprising:
an engine;
an electric motor being operably coupled to an output of the engine so as to at least assist the engine during operation of the vehicle and being capable of regenerative braking; and
a control apparatus for economical driving of a hybrid vehicle, said control apparatus including:
a display portion that displays driving information such information be representative a driving condition;
a hybrid controller being configured and arranged so as to guide an economical driving condition by considering a present fuel consumption efficiency control value according to the operation of the engine and the motor and a driving pattern fuel consumption efficiency control value according to vehicle speed and a driving condition; and
wherein the driving information being displayed includes information for guiding economical driving provided by said hybrid controller.
